(19) United States
(12) Patent Application Publication
(10) Pub. No.: US 2026/0318420 A1
(43) Pub. Date: Oct. 15, 2026

(54) HYDRAULIC GATE HOIST FACILITATING STROKE CONTROL

(71) Applicant: Gaochuang (Yancheng) Technology Transfer Co., Ltd., Yancheng (CN)

(72) Inventors: Tong YUAN, Yancheng (CN); Huandi GUO, Yancheng (CN); Changmao YUAN, Yancheng (CN)

(21) Appl. No.: 19/648,085

(22) Filed: Apr. 15, 2026

(30) Foreign Application Priority Data
Apr. 15, 2025 (CN) 202510465703.X

(51) Int. Cl. F16K 3/02; F16K 3/32; F16K 31/122; F16K 37/00

(52) U.S. Cl. CPC F16K 3/0254; F16K 3/0281; F16K 3/32; F16K 31/122; F16K 37/0041

(57) ABSTRACT

The present invention relates to a hydraulic gate hoist facilitating stroke control, including a gate guide slide base, a positioning mounting frame, a limit hydraulic cylinder, a water-blocking gate, a sliding baffle, a limit insertion rod, and a position limiting hole. The present invention prevents manual inspection of the gate guide slide base and step of frequent rubbish cleaning, and eliminates the need to check for and remove rubbish in a slideway prior to closing the gate.

### RELATED APPLICATIONS

The present patent document claims the benefit of priority to Patent Application No. 202510465703.X, filed Apr. 15, 2026, and entitled “HYDRAULIC GATE HOIST FACILITATING STROKE CONTROL,” the entire contents of each of which are incorporated herein by reference.

### BACKGROUND

### 1. Technical Field

The present invention relates to the technical field of hydraulic gate hoists, and in particular to a hydraulic gate hoist facilitating stroke control.

### 2. Background Information

In various small- and medium-sized water conservancy and pumping station projects, hydraulic gate hoists are commonly used to control opening and closing of gates. To detect a gate opening, existing hydraulic gate hoists are typically provided with displacement sensors for monitoring strokes of gates. During gate operation, a piston rod of a hydraulic cylinder is driven by forward and reverse rotation of a motor to reciprocate, thereby driving the gate to move back and forth, to implement opening and closing of the gate.

For example, CN112049838A discloses a hydraulic cylinder and a gate hoist with automatic displacement control, and the hydraulic cylinder includes a cylinder body and a piston movably disposed inside the cylinder body. The piston is fixedly connected to a piston rod, and a magnetostrictive displacement sensor is provided at an end of the piston rod. A hole penetrating the piston and communicating with a rodless chamber is provided inside the piston rod. The magnetostrictive displacement sensor is fixedly connected to a detection rod, and the detection rod is located inside the hole. A fixed rod is also provided, with one end fixedly connected to a bottom of the rodless chamber of the cylinder body and the other end located inside the hole. A magnetic ring is provided at an end of the fixed rod, and the magnetic ring is sleeved on the detection rod. Relative movement between the detection rod and the magnetic ring is used to detect relative displacement between the piston and the cylinder body. In the gate hoist, the cylinder body of the hydraulic cylinder is fixedly connected to a gate, a frame is disposed above the gate, and the piston rod is connected to the frame. The end of the piston rod of the hydraulic cylinder is located at the top of the frame. A structure of the invention prevents the magnetostrictive displacement sensor from being immersed in water for a long time and facilitates on-site maintenance and replacement.

CN117248505A discloses a high-stability hydraulic gate hoist, which belongs to the technical field of hydraulic equipment and includes a gate and a hydraulic cylinder located within a mounting frame. The mounting frame includes a bottom plate, a top plate, and two side plates, and the bottom plate, the top plate, and the two side plates form a rectangular structure. The gate is movably disposed between the two side plates, and the hydraulic cylinder is mounted on a lower surface of the top plate. A top of the gate is firmly connected to a connection box, and a piston rod of the hydraulic cylinder is connected to the connection box. Two sets of locking devices are disposed between the top plate and the gate. The invention utilizes the locking devices to lock a position of the gate when the hydraulic gate hoist raises the gate, thereby reducing a gravitational load on the hydraulic cylinder. Even if the gate has been suspended for a long time, the high stability of the hydraulic gate hoist is ensured, thereby reducing a safety risk.

However, when the gate is closed, to ensure the sealing effect of the gate, it is necessary to first check whether there is rubbish in a slideway and clean the rubbish. However, it takes a long time to check the slideway and clean the rubbish, which increases a labor burden on a user and affects the ease of use of the hydraulic gate hoist.

### BRIEF SUMMARY

In view of the above, the present invention provides a hydraulic gate hoist facilitating stroke control, which can automatically clean impurities adhering to a gate, effectively preventing the accumulation of a large amount of impurities on the gate, eliminating the inconvenience of manual cleaning, and preventing mechanical damage to an impurity cleaning scraper. According to the present invention, the service life of the hydraulic gate hoist is ensured, a gravitational load acting on a limit hydraulic cylinder is reduced, an adverse effect on the stability of the limit hydraulic cylinder caused by long-term suspension is prevented, a safety risk is lowered, and operational safety of the hydraulic gate hoist is improved. Impurities or rubbish in water are prevented from being trapped in the gate guide slide base to prevent affecting the sealing performance of the gate, and cement concrete is prevented from entering the gate guide slide base during pouring. Manual inspection of the gate guide slide base is effectively obviated, inconvenience caused by frequent rubbish removal is prevented, a significant amount of time is saved, labor burden on a user is reduced, convenience of use of the hydraulic gate hoist is improved, and operational performance of the hydraulic gate hoist is ensured.

The present invention provides a hydraulic gate hoist facilitating stroke control, specifically including a gate guide slide base, a positioning mounting frame, a limit hydraulic cylinder, and a water-blocking gate, where the positioning mounting frame is fixedly connected to an upper part of the gate guide slide base; the limit hydraulic cylinder is bolted to an upper part of the positioning mounting frame, and a displacement sensor is disposed inside the limit hydraulic cylinder; and the water-blocking gate is slidably connected to an inner side of the gate guide slide base in an up-down direction, and the water-blocking gate is fixedly connected to a piston rod of the limit hydraulic cylinder; and further including sliding baffles, a cleaning structure, a first limit structure, limit insertion rods, a second limit structure, and position limiting holes, where two sliding baffles are provided, and the two sliding baffles are respectively slidably connected to left and right sides of the gate guide slide base in a front-rear direction; the cleaning structure is disposed below the positioning mounting frame; the first limit structure is disposed above the gate guide slide base; two limit insertion rods are provided, and the two limit insertion rods are respectively slidably connected to the left and right sides of the gate guide slide base in an up-down direction; the second limit structure is disposed at the upper part of the gate guide slide base; and an upper part of the sliding baffle is provided with a position limiting hole cooperating with the limit insertion rod.

Further, the cleaning structure includes debris discharge outlets and first limit baffles; two debris discharge outlets are provided, and the two debris discharge outlets are respectively formed on the left and right sides of the gate guide slide base; two first limit baffles are provided, and the two first limit baffles are respectively fixedly connected to the left and right sides of the gate guide slide base.

Further, the cleaning structure includes an impurity cleaning scraper and return spiral springs, and the impurity cleaning scraper is rotatably connected to the upper part of the gate guide slide base; and two return spiral springs are provided, and the impurity cleaning scraper is elastically connected to the gate guide slide base through the two return spiral springs.

Further, the first limit structure includes second limit baffles and first return elastic members, multiple second limit baffles are provided, and the multiple second limit baffles are evenly distributed and slidably connected to the upper part of the positioning mounting frame; multiple first return elastic members are provided, and the multiple second limit baffles are elastically connected to the positioning mounting frame through the multiple first return elastic members.

Further, the first limit structure includes first limit metal pieces and second electromagnets; multiple first limit metal pieces are provided, and the multiple first limit metal pieces are evenly distributed and fixedly connected to outer sides of the multiple second limit baffles; multiple second electromagnets are provided, and the multiple second electromagnets are evenly distributed and fixedly connected to an inner side of the positioning mounting frame, and control circuits of the multiple second electromagnets are all connected in parallel with a control circuit of the limit hydraulic cylinder.

Further, the first limit structure includes an anti-accumulation inclined platform and a matching slot; the anti-accumulation inclined platform is fixedly connected to a lower part of the gate guide slide base; and the matching slot is provided at a lower part of the water-blocking gate, and a sealing rubber pad is bonded inside the matching slot.

Further, the first limit structure includes position limiting plates, two position limiting plates are provided, and the two position limiting plates are respectively fixedly connected to left and right sides of an upper end of the water-blocking gate.

Further, the second limit structure includes first electromagnets and second return elastic members; two first electromagnets are provided, the two first electromagnets are respectively fixedly connected to the left and right sides of the gate guide slide base, and control circuits of the two first electromagnets are both connected in parallel with a control circuit of the limit hydraulic cylinder; and multiple second return elastic members are provided, and the two sliding baffles are respectively elastically connected to the gate guide slide base through the multiple second return elastic members.

Further, the second limit structure includes second limit metal pieces and third return elastic members; two second limit metal pieces are provided, and the two second limit metal pieces are respectively fixedly connected to upper parts of the two limit insertion rods; and two third return elastic members are provided, and the two limit insertion rods are elastically connected to the gate guide slide base through the two third return elastic members.

### Beneficial Effects

According to the present invention, the impurity cleaning scraper cleans impurities adhering to the gate, effectively preventing excessive accumulation of impurities on the gate and preventing inconvenience caused by manual cleaning of the gate. In addition, the return spiral spring enables the impurity cleaning scraper to swing when subjected to a large thrust, thereby preventing mechanical damage to the impurity cleaning scraper, and ensuring the service life of the hydraulic gate hoist. The second limit baffle and the position limiting plate can limit a position of the water-blocking gate, so that a gravitational load acting on a limit hydraulic cylinder is reduced, an adverse effect on the stability of the limit hydraulic cylinder caused by long-term suspension is prevented, a safety risk is lowered, and operational safety of the hydraulic gate hoist is improved. Impurities or rubbish in water are prevented by the sliding baffle from being trapped in the gate guide slide base to prevent affecting the sealing performance of the gate, and cement concrete is prevented from entering the gate guide slide base during pouring. Manual inspection of the gate guide slide base is effectively obviated, inconvenience caused by frequent rubbish removal is prevented, a significant amount of time is saved, labor burden on a user is reduced, convenience of use of the hydraulic gate hoist is improved, and operational performance of the hydraulic gate hoist is ensured.

### BRIEF DESCRIPTION OF THE DRAWINGS

To more clearly illustrate technical solutions of embodiments of the present invention, drawings of the embodiments are briefly introduced below.

The drawings described below relate only to some embodiments of the present invention and do not limit the present invention.

### In the Drawings

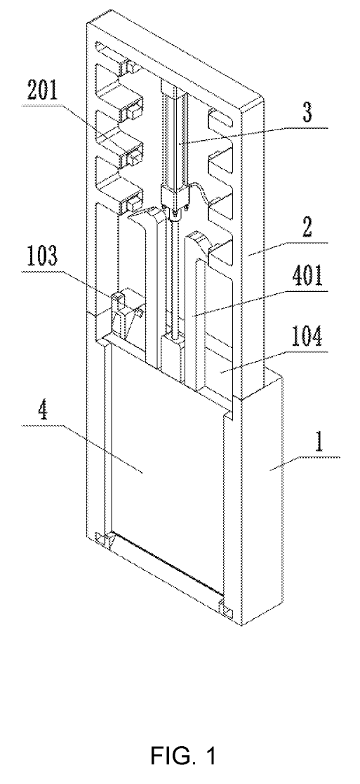

FIG. 1 is a schematic diagram of an overall structure of the present invention.

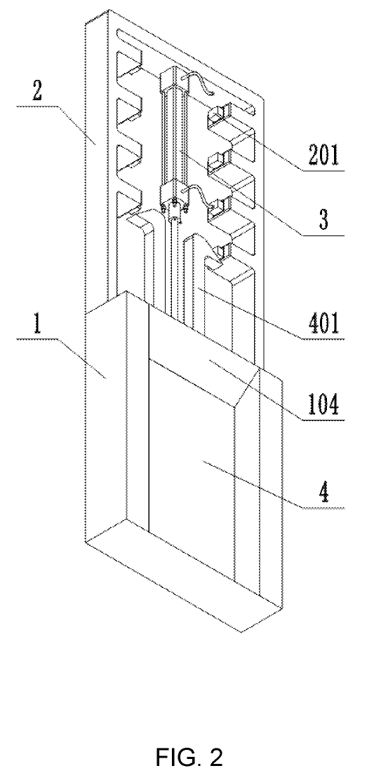

FIG. 2 is a schematic diagram of a mounting position of an impurity cleaning scraper of the present invention.

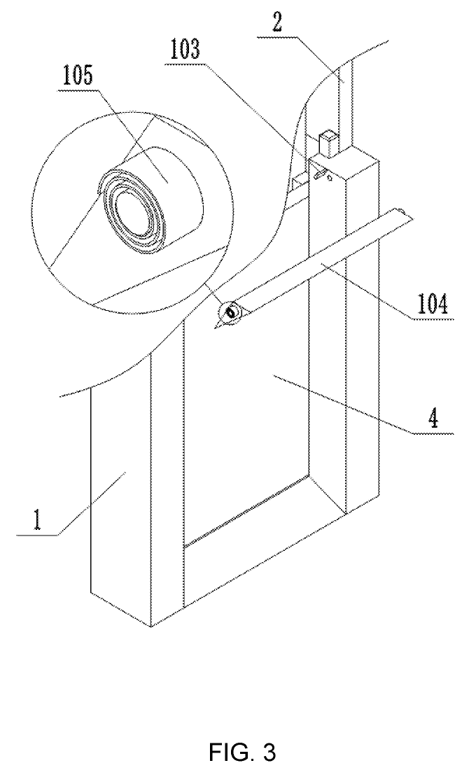

FIG. 3 is an exploded structural schematic diagram of a gate guide slide base and the impurity cleaning scraper of the present invention.

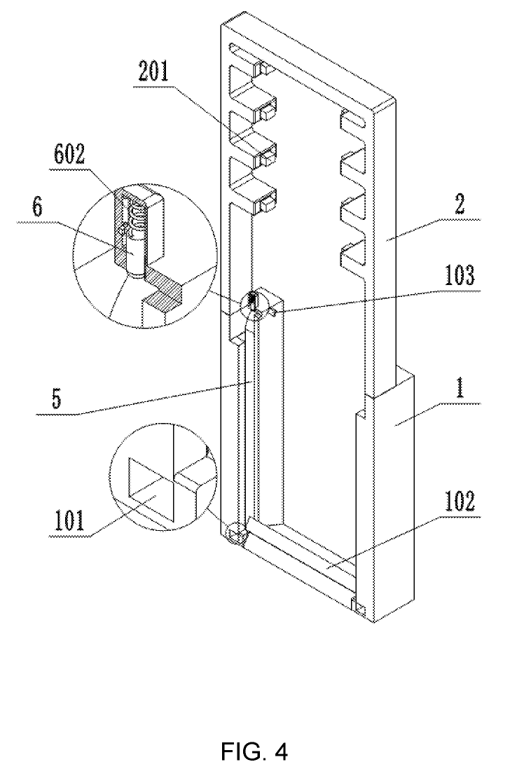

FIG. 4 is a schematic diagram of a mounting position of a limit insertion rod of the present invention.

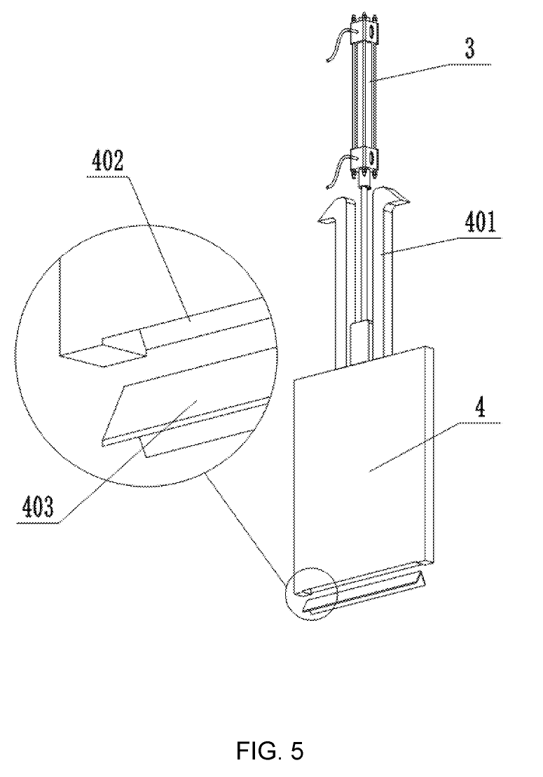

FIG. 5 is an exploded structural schematic diagram of a water-blocking gate and a sealing rubber pad of the present invention.

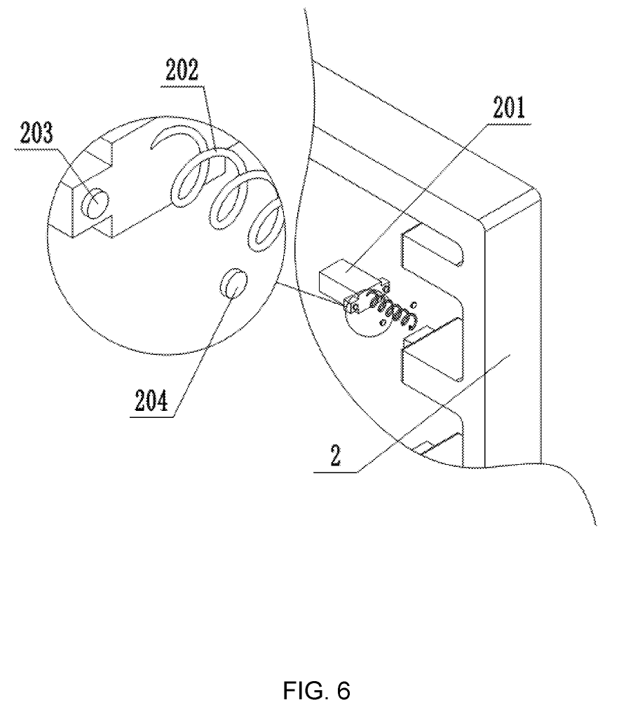

FIG. 6 is an exploded structural schematic diagram of a positioning mounting frame, a second limit baffle, and a second electromagnet of the present invention.

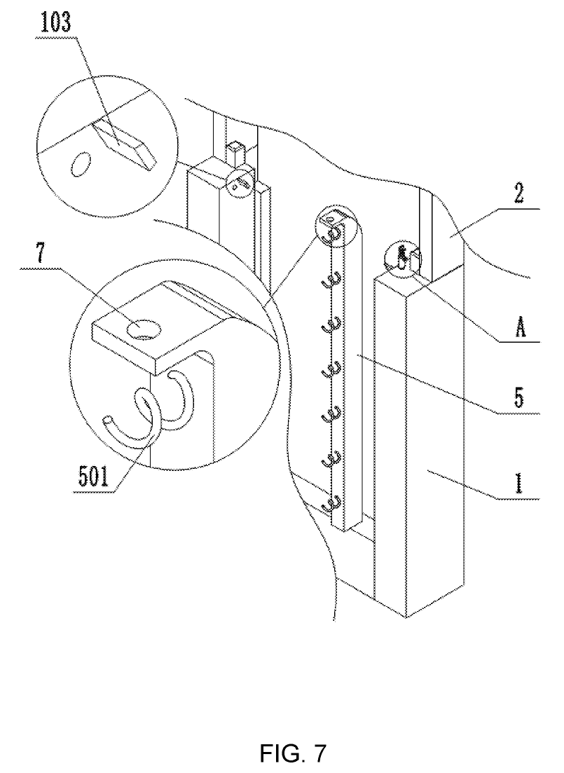

FIG. 7 is an exploded structural schematic diagram of the gate guide slide base, a sliding baffle, the limit insertion rod, and a first electromagnet of the present invention.

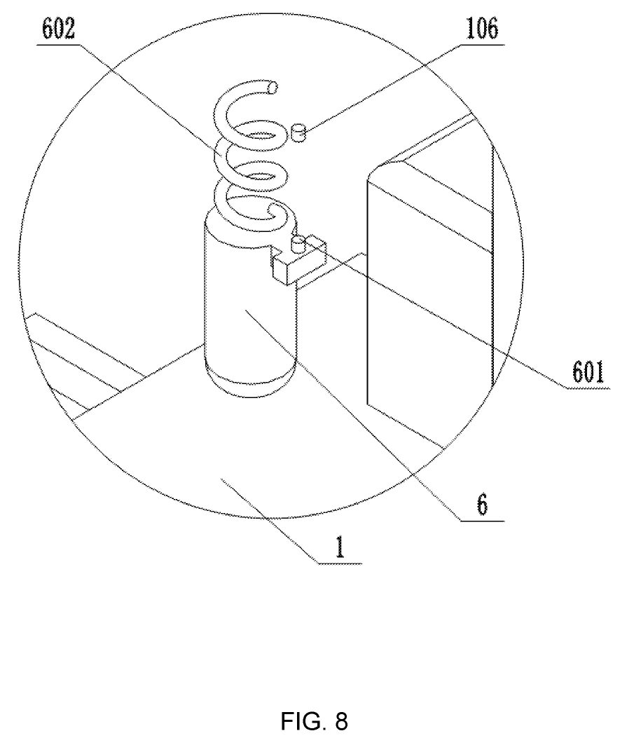

FIG. 8 is a partially enlarged structural schematic diagram of area A in FIG. 7 of the present invention.

### LIST OF REFERENCE NUMERALS IN THE DRAWINGS

1, gate guide slide base, 101, debris discharge outlet, 102, anti-accumulation inclined platform, 103, first limit baffle, 104, impurity cleaning scraper, 105, return spiral spring, 106, first electromagnet, 2, positioning mounting frame, 201, second limit baffle, 202, first return elastic member, 203, first limit metal piece, 204, second electromagnet, 3, limit hydraulic cylinder, 4, water-blocking gate, 401, position limiting plate, 402, matching slot, 403, sealing rubber pad, 5, sliding baffle, 501, second return elastic member, 6, limit insertion rod, 601, second limit metal piece, 602, third return elastic member, 7, position limiting hole.

### DETAILED DESCRIPTION OF THE DRAWINGS AND THE PRESENTLY PREFERRED EMBODIMENTS

### First Embodiment

Refer to FIGS. 1 to 5:

The present invention provides a hydraulic gate hoist facilitating stroke control, including a gate guide slide base 1, a positioning mounting frame 2, a limit hydraulic cylinder 3, a water-blocking gate 4, a sliding baffle 5, a cleaning structure, and a first limit structure. The positioning mounting frame 2 is fixedly connected to an upper part of the gate guide slide base 1. The limit hydraulic cylinder 3 is bolted to an upper part of the positioning mounting frame 2, and a displacement sensor is disposed inside the limit hydraulic cylinder 3. The water-blocking gate 4 is slidably connected to an inner side of the gate guide slide base 1 in an up-down direction, and the water-blocking gate 4 is fixedly connected to a piston rod of the limit hydraulic cylinder 3. Two sliding baffles 5 are provided, and the two sliding baffles 5 are respectively slidably connected to left and right sides of the gate guide slide base 1 in a front-rear direction. The cleaning structure is disposed below the positioning mounting frame 2. The first limit structure is disposed above the gate guide slide base 1.

The cleaning structure includes debris discharge outlets 101 and first limit baffles 103. Two debris discharge outlets 101 are provided, and the two debris discharge outlets 101 are respectively formed on the left and right sides of the gate guide slide base 1. Two first limit baffles 103 are provided, and the two first limit baffles 103 are respectively fixedly connected to the left and right sides of the gate guide slide base 1.

The cleaning structure further includes an impurity cleaning scraper 104 and return spiral springs 105. The impurity cleaning scraper 104 is rotatably connected to the upper part of the gate guide slide base 1. Two return spiral springs 105 are provided, and the impurity cleaning scraper 104 is elastically connected to the gate guide slide base 1 through the two return spiral springs 105.

The first limit structure includes second limit baffles 201 and first return elastic members 202. Multiple second limit baffles 201 are provided, and the multiple second limit baffles 201 are evenly distributed and slidably connected to the upper part of the positioning mounting frame 2. Multiple first return elastic members 202 are provided, and the multiple second limit baffles 201 are elastically connected to the positioning mounting frame 2 through the multiple first return elastic members 202.

The first limit structure further includes first limit metal pieces 203 and second electromagnets 204. Multiple first limit metal pieces 203 are provided, and the multiple first limit metal pieces 203 are evenly distributed and fixedly connected to outer sides of the multiple second limit baffles 201. Multiple second electromagnets 204 are provided, and the multiple second electromagnets 204 are evenly distributed and fixedly connected to an inner side of the positioning mounting frame 2. Control circuits of the multiple second electromagnets 204 are all connected in parallel with a control circuit of the limit hydraulic cylinder 3.

The first limit structure further includes an anti-accumulation inclined platform 102 and a matching slot 402. The anti-accumulation inclined platform 102 is fixedly connected to a lower part of the gate guide slide base 1. The matching slot 402 is provided at a lower part of the water-blocking gate 4.

The first limit structure further includes position limiting plates 401 and a sealing rubber pad 403. Two position limiting plates 401 are provided, and the two position limiting plates 401 are respectively fixedly connected to left and right sides of the water-blocking gate 4. The sealing rubber pad 403 is bonded to an inner side of the matching slot 402.

Specific usage and functions of this embodiment: The gate guide slide base 1 and the positioning mounting frame 2 are cast in a river channel, when a gate needs to be closed, the limit hydraulic cylinder 3 is started, at this time, the second electromagnet 204 is powered on to attract the first limit metal piece 203 and the second limit baffle 201 to retract, and after the second limit baffle 201 retracts, the position limiting plate 401 is no longer limited; the limit hydraulic cylinder 3 can push the water-blocking gate 4 to move downward, when the water-blocking gate 4 moves downward, the sliding baffle 5 is pressed, causing the sliding baffle 5 to retract into the gate guide slide base 1, and dust in a gap between the gate guide slide base 1 and the sliding baffle 5 falls into the debris discharge outlet 101; after the matching slot 402 at the lower part of the water-blocking gate 4 is engaged with the anti-accumulation inclined platform 102, the gate is completely closed, and the sealing rubber pad 403 can fill a gap between the matching slot 402 and the anti-accumulation inclined platform 102; the displacement sensor can monitor a movement distance of the gate in real time, after the gate moves to a proper position, the displacement sensor can promptly send a signal to a control system to stop the limit hydraulic cylinder 3, and after the limit hydraulic cylinder 3 is powered off, the first return elastic member 202 pushes the second limit baffle 201 to reset, so that the second limit baffle 201 limits the position limiting plate 401; and when the gate is opened, the impurity cleaning scraper 104 is always attached to the water-blocking gate 4 under the limitation of the first limit baffle 103, as the water-blocking gate 4 moves, the impurity cleaning scraper 104 scrapes off impurities adhering to the water-blocking gate 4, and after the water-blocking gate 4 is fully opened, the return spiral spring 105 can cause, when the impurity cleaning scraper 104 is subject to a thrust, the impurity cleaning scraper 104 to swing.

### Second Embodiment

As shown in FIGS. 2 to 8,

on the basis of the first embodiment, the present invention further includes limit insertion rods 6, a second limit structure, and position limiting holes 7. Two limit insertion rods 6 are provided, and the two limit insertion rods 6 are respectively slidably connected to the left and right sides of the gate guide slide base 1 in an up-down direction. The second limit structure is disposed at the upper part of the gate guide slide base 1. Two position limiting holes 7 are provided, and the two position limiting holes 7 are respectively provided at upper parts of the two sliding baffles 5.

The second limit structure includes first electromagnets 106 and a second return elastic member 501. Two first electromagnets 106 are provided, the two first electromagnets 106 are respectively fixedly connected to the left and right sides of the gate guide slide base 1, and control circuits of the two first electromagnets 106 are both connected in parallel with a control circuit of the limit hydraulic cylinder 3. Multiple second return elastic members 501 are provided, and the two sliding baffles 5 are respectively elastically connected to the gate guide slide base 1 through the multiple second return elastic members 501.

The second limit structure further includes second limit metal pieces 601 and third return elastic members 602. Two second limit metal pieces 601 are provided, and the two second limit metal pieces 601 are respectively fixedly connected to upper parts of the two limit insertion rods 6. Two third return elastic members 602 are provided, and the two limit insertion rods 6 are elastically connected to the gate guide slide base 1 through the two third return elastic members 602.

Specific usage and functions of this embodiment: When the limit hydraulic cylinder 3 is powered on, the first electromagnet 106 is also powered on, at this time, the first electromagnet 106 attracts the second limit metal piece 601 and the limit insertion rods 6 to slide upward and leave the position limiting hole 7, so that the sliding baffle 5 automatically retracts into the gate guide slide base 1 after being pressed by the water-blocking gate 4, the second return elastic member 501 can push, after a valve is opened, the sliding baffle 5 to reset, and after the limit hydraulic cylinder 3 is powered off, the first electromagnet 106 is also powered off, and the third return elastic member 602 pushes the limit insertion rod 6 to reset and reinsert into the position limiting hole 7 to position the sliding baffle 5.

The following points should be noted in this specification.
1. The accompanying drawings of the embodiments of this disclosure only relate to the structures related to the embodiments of this disclosure. Refer to conventional designs for other structures.
2. Without any conflict, the embodiments of this disclosure and the features in the embodiments can be combined with each other to obtain new embodiments.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

1. A hydraulic gate hoist facilitating stroke control, comprising a gate guide slide base, a positioning mounting frame, a limit hydraulic cylinder, and a water-blocking gate, wherein the positioning mounting frame is fixedly connected to an upper part of the gate guide slide base; the limit hydraulic cylinder is bolted to an upper part of the positioning mounting frame, and a displacement sensor is disposed inside the limit hydraulic cylinder; and the water-blocking gate is slidably connected to an inner side of the gate guide slide base in an up-down direction, and the water-blocking gate is fixedly connected to a piston rod of the limit hydraulic cylinder; and further comprising sliding baffles, a cleaning structure, a first limit structure, limit insertion rods, a second limit structure, and position limiting holes, wherein two sliding baffles are provided, and the two sliding baffles are respectively slidably connected to left and right sides of the gate guide slide base in a front-rear direction; the cleaning structure is disposed below the positioning mounting frame; the first limit structure is disposed above the gate guide slide base; two limit insertion rods are provided, and the two limit insertion rods are respectively slidably connected to the left and right sides of the gate guide slide base in an up-down direction; the second limit structure is disposed at the upper part of the gate guide slide base; and an upper part of the sliding baffle is provided with a position limiting hole cooperating with the limit insertion rod.

2. The hydraulic gate hoist facilitating stroke control according to claim 1, wherein the cleaning structure comprises debris discharge outlets and first limit baffles; two debris discharge outlets are provided, and the two debris discharge outlets are respectively formed on the left and right sides of the gate guide slide base; two first limit baffles are provided, and the two first limit baffles are respectively fixedly connected to the left and right sides of the gate guide slide base.

3. The hydraulic gate hoist facilitating stroke control according to claim 1, wherein the cleaning structure further comprises an impurity cleaning scraper and return spiral springs, and the impurity cleaning scraper is rotatably connected to the upper part of the gate guide slide base; and two return spiral springs are provided, and the impurity cleaning scraper is elastically connected to the gate guide slide base through the two return spiral springs.

4. The hydraulic gate hoist facilitating stroke control according to claim 1, wherein the first limit structure comprises second limit baffles and first return elastic members, multiple second limit baffles are provided, and the multiple second limit baffles are evenly distributed and slidably connected to the upper part of the positioning mounting frame; multiple first return elastic members are provided, and the multiple second limit baffles are elastically connected to the positioning mounting frame through the multiple first return elastic members.

5. The hydraulic gate hoist facilitating stroke control according to claim 4, wherein the first limit structure further comprises first limit metal pieces and second electromagnets; multiple first limit metal pieces are provided, and the multiple first limit metal pieces are evenly distributed and fixedly connected to outer sides of the multiple second limit baffles; multiple second electromagnets are provided, and the multiple second electromagnets are evenly distributed and fixedly connected to an inner side of the positioning mounting frame, and control circuits of the multiple second electromagnets are all connected in parallel with a control circuit of the limit hydraulic cylinder.

6. The hydraulic gate hoist facilitating stroke control according to claim 1, wherein the first limit structure further comprises an anti-accumulation inclined platform and a matching slot; the anti-accumulation inclined platform is fixedly connected to a lower part of the gate guide slide base; and the matching slot is provided at a lower part of the water-blocking gate, and a sealing rubber pad is bonded inside the matching slot.

7. The hydraulic gate hoist facilitating stroke control according to claim 6, wherein the first limit structure further comprises position limiting plates, two position limiting plates are provided, and the two position limiting plates are respectively fixedly connected to left and right sides of an upper end of the water-blocking gate.

8. The hydraulic gate hoist facilitating stroke control according to claim 1, wherein the second limit structure comprises first electromagnets and second return elastic members; two first electromagnets are provided, the two first electromagnets are respectively fixedly connected to the left and right sides of the gate guide slide base, and control circuits of the two first electromagnets are both connected in parallel with a control circuit of the limit hydraulic cylinder; and multiple second return elastic members are provided, and the two sliding baffles are respectively elastically connected to the gate guide slide base through the multiple second return elastic members.

9. The hydraulic gate hoist facilitating stroke control according to claim 1, wherein the second limit structure further comprises second limit metal pieces and third return elastic members; two second limit metal pieces are provided, and the two second limit metal pieces are respectively fixedly connected to upper parts of the two limit insertion rods; and two third return elastic members are provided, and the two limit insertion rods are elastically connected to the gate guide slide base through the two third return elastic members.
